(19) United States
(12) Patent Application Publication
(10) Pub. No.: US 2006/0236841 A1
(43) Pub. Date: Oct. 26, 2006

(54) Machine for changing the key of a stringed musical instrument

(76) Inventor: Curtis Robert LeBlanc, Thibodaux, LA (US)

Correspondence Address: CURTIS ROBERT LEBLANC, 153 CHISHOLM TRAIL, THIBODAUX, LA, 70301, US

(21) Appl. No.: 11/359,082

(22) Filed: Feb. 21, 2006

Related U.S. Application Data
(60) Provisional application No. 60/655,215, filed on Feb. 22, 2005.

(51) Int. Cl. G10D 3/04

(52) U.S. Cl. 84/298

(57) ABSTRACT

The present invention relates to a machine for changing the key of a stringed musical instrument. The machine includes a mounting base, a structure for securing the mounting base to the stringed musical instrument, a housing body to provide a space to accommodate tuning mechanisms, a plurality of control rod assemblies to selectively adjustment for several tunings, a plurality of tuner switch rod assemblies to provide mechanisms to switch between tunings, a set of tuning mechanisms on each control rod assembly for fine adjustment of tuning while in use, a plurality of bridge rollers to adjust height and intonation of strings, a top plate with a plurality of tuner switch screw slots that provide access to the tuner switch rod assemblies, which provide a choice from different tunings, and a lever body to relieve string tension while changing tunings.

### CROSS REFERENCE TO RELATED APPLICATIONS

This application is based on provisional application Ser. No. 60/655,215, filed on Feb. 22, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The present invention relates generally to tuning devices for stringed musical instruments, and more particularly, to a machine for changing the key of a stringed musical instrument.

Guitars are a popular form of musical expression all over the world. A majority of guitars utilize, a single tuning configuration, this allows only one setting of tuned strings per instrument. Before playing the instrument, this tuning must be provided for each string in the desired key via string manipulation.

Many artists who perform with stringed instruments, such as guitars, wish to be able to change the general key in which the instrument is tuned. This change is desired to change the overall sound that the instrument can create. Artistic expression of the artist is, therefore, limited, if the musician cannot change the tuning configuration of the strings of a guitar quickly and efficiently.

Manually changing the tension of guitar strings can be a time-consuming process. It takes time to tune all the strings to the general key of the instrument. During a concert performance, performing this task between songs is difficult if not impossible to accomplish and during practice it is counter productive to the writing process.

During a song, manually changing the tuning of a guitar with traditional tuning means is all but impossible, especially given the sophistication of live audiences, who can sense an out of tune string on a guitar.

U.S. Pat. No. 5,438,902, issued in the name of Baker, discloses a multi-tuner for stringed musical instruments wherein an adjustable cam mechanism allows the user to select different predefined string tensions for all of the strings by rotating the cam; whereas, the disclosed invention can extend the number of predefined tuning sets by spreading the selection means across a leverage arm.

U.S. Pat. No. 3,479,917, issued in the name of Zitnik, Jr. et al., discloses a multiple lever tone changer for guitars, wherein individual levers are provided to allow the musician to create a vibrato effect, either on a single string or on the entire set of strings. It does not change the entire key in which the instrument can be tuned; therefore, it would be favorable to design a machine for changing the key of a stringed musical instrument as shown in this disclosure.

Two patents disclose bridge assemblies for guitars that incorporate adjustable intonation means: U.S. Pat. No. 4,867,031, issued in the name of Fender and U.S. Pat. No. 5,602,353, issued in the name of Juszkiewicz et al.

Several patents disclose bridge assemblies for guitars that incorporate adjustment means for changing individual string tension, intonation, and saddle height: U.S. Pat. No. 4,625,613, issued in the name of Steinberger, U.S. Pat. No. 4,688,461, issued in the name of Stroh, U.S. Pat. No. 5,265,512, issued in the name of Kubicki et al., and U.S. Pat. No. 5,539,143, issued in the name of Rose.

Several patents disclose automatic string tension adjusting means for stringed instruments that maintains a predefined tone for each string by electronically monitoring the string tone and adjusting it via an electric motor. These include U.S. Pat. No. 2,624,027, issued in the name of Clark, U.S. Pat. No. 4,928,563, issued in the name of Murata et al., and U.S. Pat. No. 5,095,797, issued in the name of Zacaroli. Such devices, however, are expensive and complicated, and as such are prone to electronic component failure with repeated use.

A search of the prior art did not disclose any patents that read directly on the claims of the instant invention.

Of considerable relevance is U.S. Pat. No. 5,542,330, issued in the name of Borisoff. The '330 patent discloses a multi-tuner for stringed musical instruments wherein an adjustable lever mechanism allows the user to select, on a per string basis, from three different predefined string tensions.

There are several problems with the '330 device. First, the '330 device is designed to use the mounting mechanism on a flat mount guitar. Since the '330 device is designed to function mainly on a flat mount guitar configuration, it is not designed to be used with the vast majority of stringed instruments, such as Gibson Les Paul. TM. Guitars. Second, the '330 device connects to the guitar face by screwing a flat plate directly to the guitar face which may incur irreversible damage to the instrument. Whereas, within this disclosure the invention shown provides a stronger means of securing the invention to the instrument and secures to pre-existing mounting hardware.

While the general concept of the per string, multi-position tuning feature is incorporated into this invention in combination, other elements are different enough as to make the combination distinguished over the inventors' own prior art. Consequently, a need has therefore been felt for an improved but less complex mechanism that provides per string multi-position tuning capabilities for stringed musical instruments.

### BRIEF SUMMARY OF THE INVENTION

The primary object of the invention is to provide a method and apparatus for the player of the stringed musical instrument to switch from one pre selected tuning to a number of other pre selected tunings.

Another object of the invention is to provide a method and apparatus for the player of the stringed musical instrument to adjust fine amounts of sting tension so the player can keep the instrument in tune.

Another object of the invention is to provide a structure to more securely affix the apparatus to the instrument and improve its tonal quality and control.

A further object of the invention is to provide an apparatus for a stringed musical instrument that is aesthetically pleasing.

Yet, another object of the invention is to provide an apparatus for a stringed musical instrument that is easy to install and setup.

Still yet, another object of the invention is to provide an apparatus for a stringed musical instrument that is easy to remove without damaging the instrument.

Other objects and advantages of the present invention will become apparent from the following descriptions, taken in connection with the accompanying drawings, wherein, by way of illustration and example, an embodiment of the present invention is disclosed.

In accordance with a preferred embodiment of the present invention, there is disclosed a machine for changing the key of a stringed musical instrument of simplified design, that can be used with any existing guitar configurations.

Therefore, it is an object of the present invention to more securely affix the invention to a stringed musical instrument improving its tonal quality and control by adding weight and rigidity, while improving the acoustic characteristics of the instrument.

Another object of the present invention is to provide an apparatus for a stringed musical instrument that is easy to install, setup, and remove without damaging the instrument, while leaving the instrument aesthetically pleasing and comfortable to the musician while playing the musical instrument.

A further object of the present invention is to provide a method and apparatus for the player of the stringed musical instrument to switch instantaneously from one pre selected tuning to a number of other pre selected tunings already installed on the instrument.

Yet, a further object of the present invention is to provide a method and apparatus for the player of the stringed musical instrument to be capable of adjusting the height of the instruments strings, that permits variations in intonation, allowing the strings to stress while in use from either playing or tuning the instrument.

Still another object of the present invention is to provide a method and apparatus for the player of the stringed musical instrument ability to adjust fine amounts of string tension so the player can keep the instrument in tune.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understandings of the invention.

FIGS. 1a and 1b show prior art

FIG. 2 shows a perspective view of the preferred embodiment of a machine for changing the key of a stringed musical instrument fully assembled and attached to a stringed musical instrument.

FIGS. 3,4,5,6, and 7 show various component detail and views, explaining their general shape and placement.

FIG. 8 shows a plain view of the fully assembled invention for the cut away view layouts.

FIGS. 9 and 10 illustrate the cut away path of each component and are meant to show the relation of each component within the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

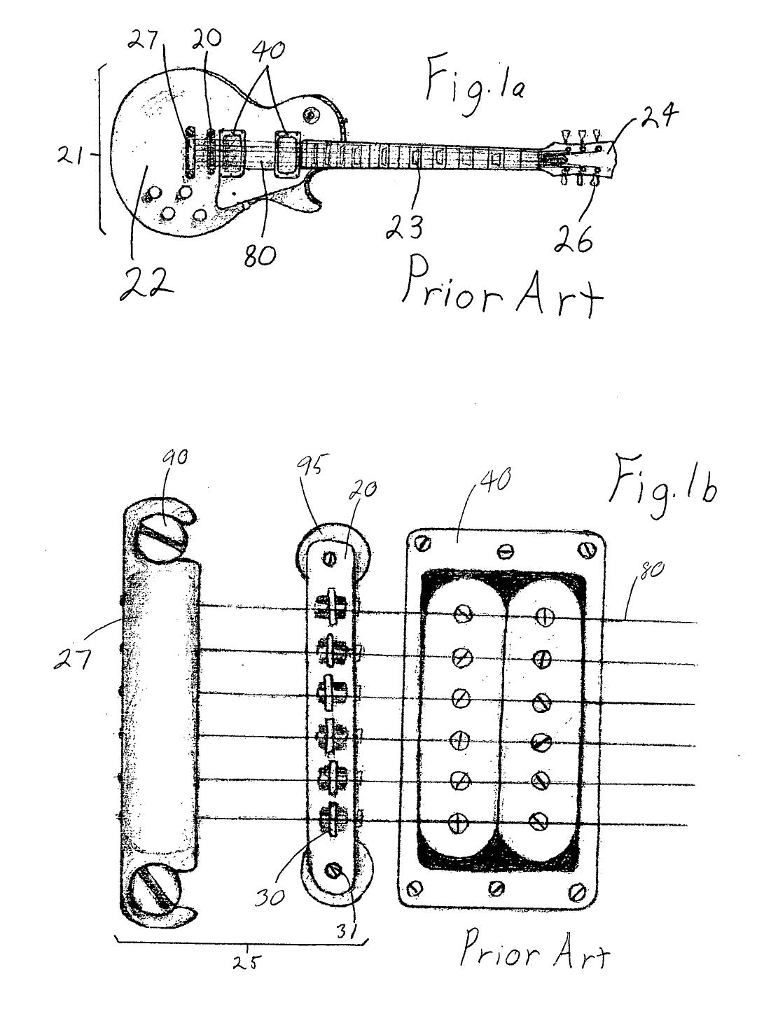

FIGS. 1a and 1b Show Prior Art

Referring to, FIG. 1a, It shows a perspective view of a exemplary stringed musical instrument 21 of the electric configuration, illustrating placement of a guitar body 22, a guitar neck 23 extending from the guitar body 22. A head stock 24 disposed at the end of the guitar neck 23. The head stock 24 has a plurality of tuning pegs 26 which can selectively increase or decrease the tension placed on a plural of strings 80, further illustrating the placement of a stop tailpiece 27, and a bridge system 20. As is commonly known in the previous art, one end of each string 80 is extended through the stop tailpiece 27 along the elongated centerline of the stringed musical instrument 21, transversely over the bridge system 20 and a plural of generally rectangular electric guitar pickups 40 winding around each tuning peg 26. Each of the strings 80 are pulled tight across the guitar neck 23 and guitar body 22 by continued rotation of the tuning pegs 26 until the desired tones are achieved.

FIG. 1b, Refers to a plain view of the bridge area 25, on the exemplary stringed musical instrument 21, illustrating a more detailed view of the stop tailpiece 27, and the bridge system 20. Further showing a plural of stop tail piece bolts 90 located on each side toward the back of the elongated centerline where the strings 80 are. Said stop tailpiece bolts 90 used to secure the stop tailpiece 27 to the guitar body 22 (as shown in FIG. 1 a), and to hold one end of the guitar strings 80. A plural of bridge support nuts 95 placed under each side of the bridge system 20 for adjusting the height of said bridge system 20. Further showing a plural of string saddles 30 positioned transversely to and below the plural of strings 80 also attached to the bridge system 20 for the purpose of intonation, showing the prior art this exemplary embodiment is designed to replace. Also a plural of bridge post 31 that are generally elongated cylindrical columns with external threads, to facilitate the adjustment of the height of said bridge system 20. Further showing the electric guitar pickups 40 positioned just in front of the bridge system 20.

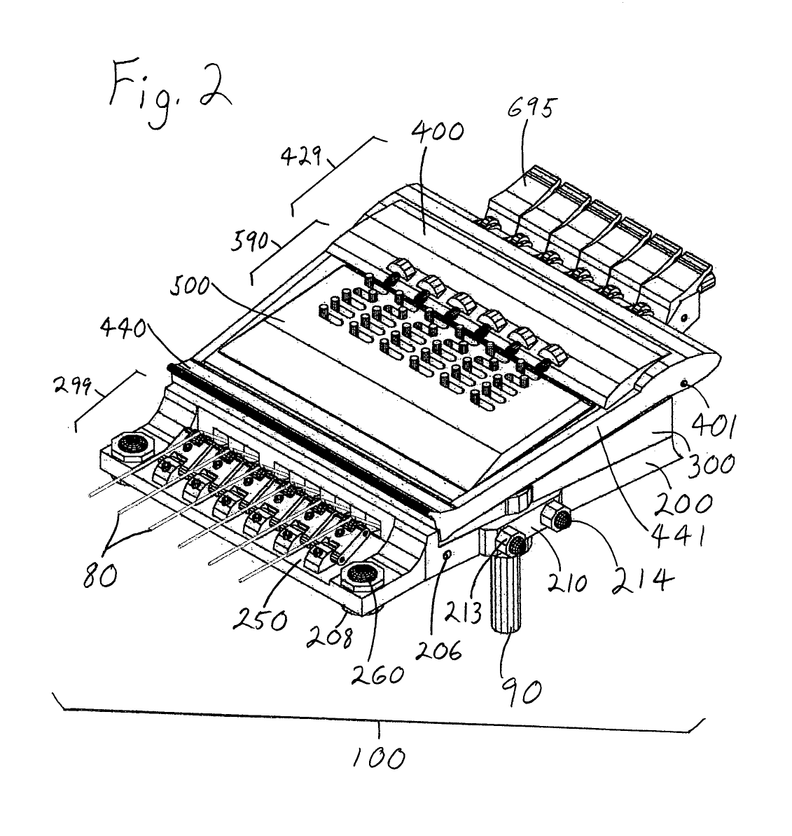

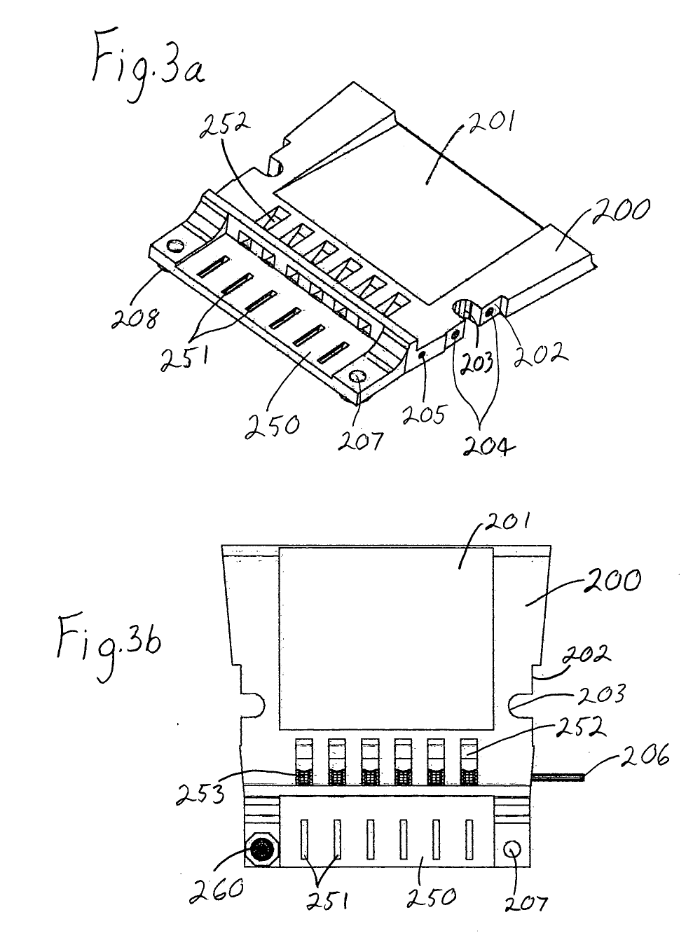

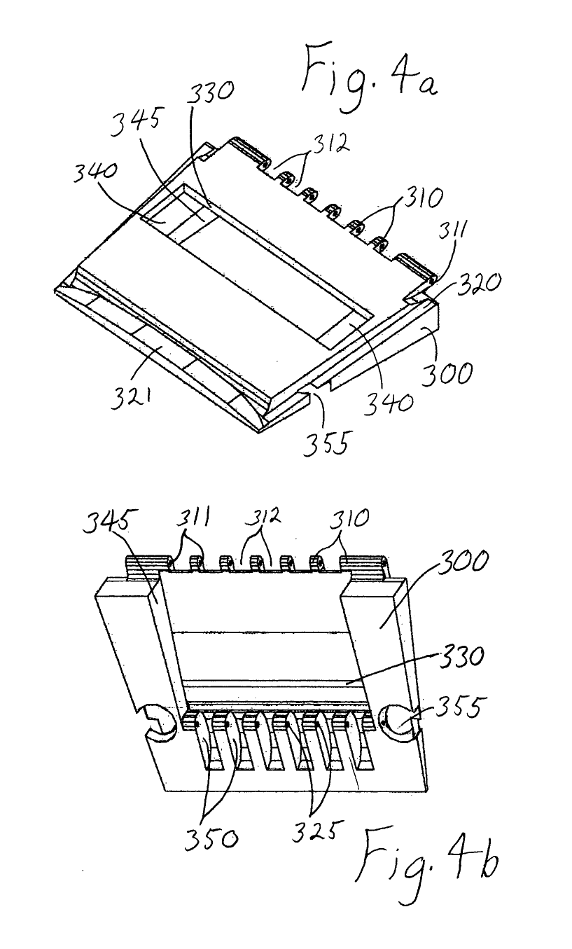

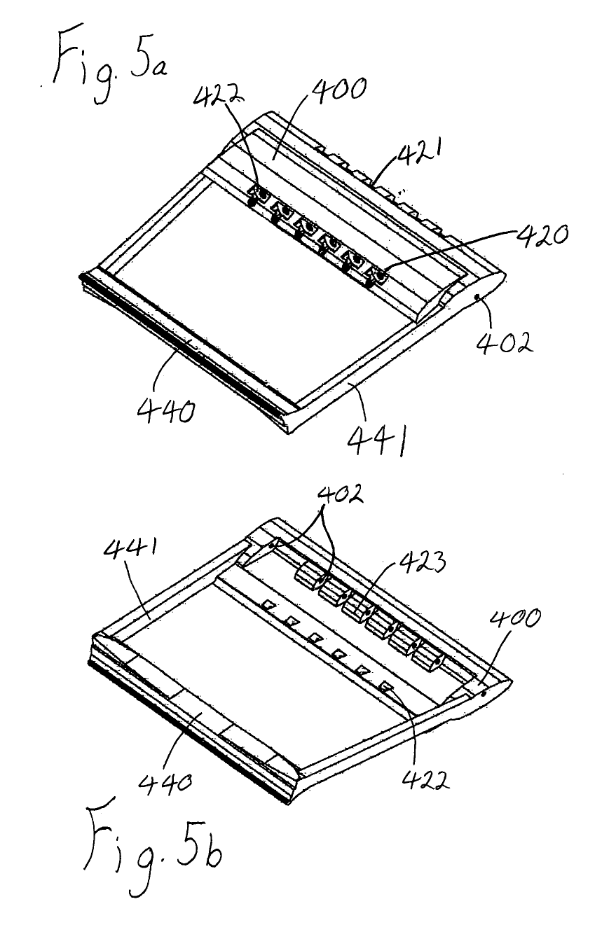

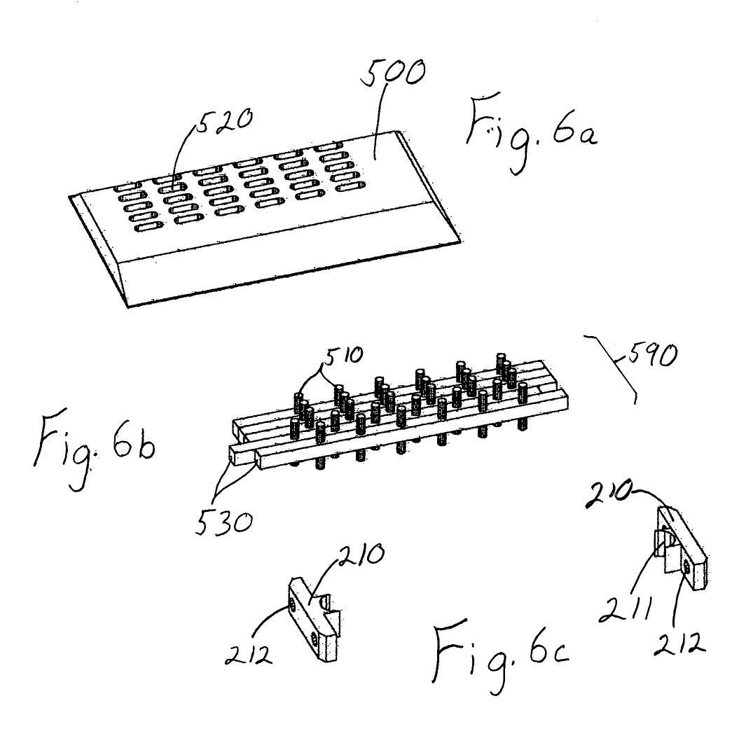

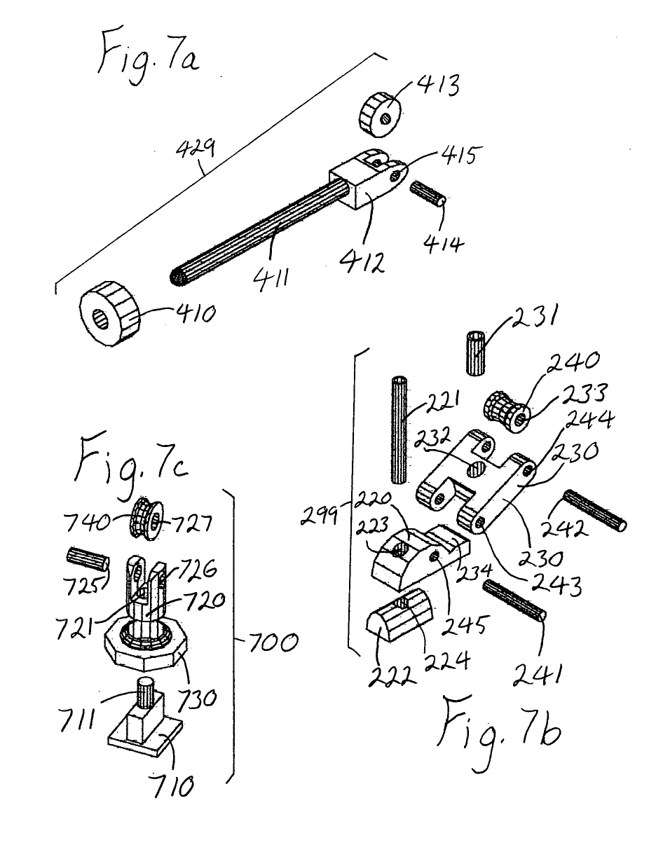

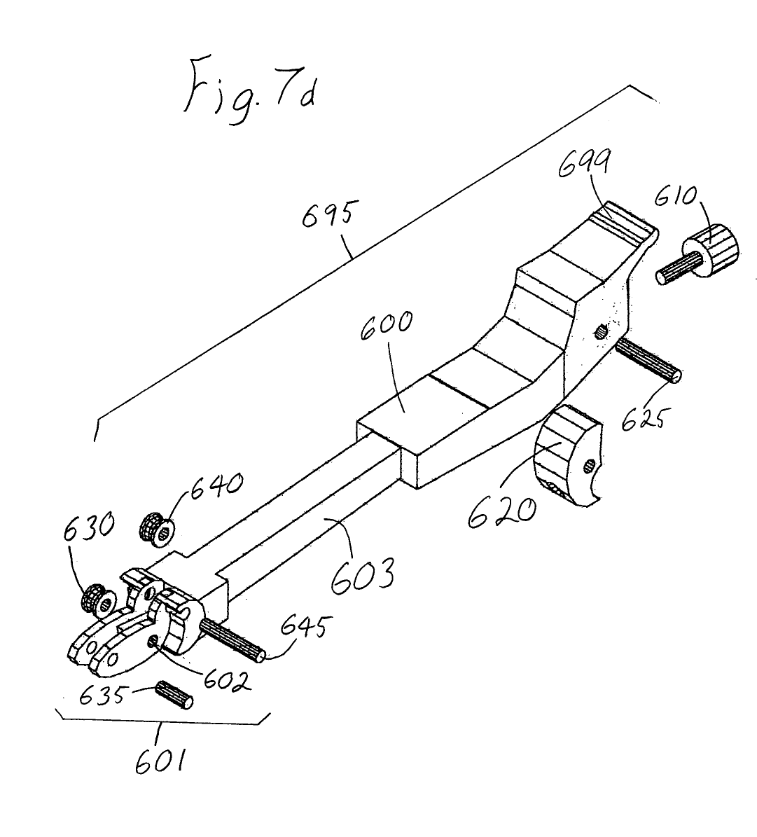

Referring now to, FIG. 2. It shows a perspective view of the preferred embodiment of a machine for changing the key of a stringed musical instrument 100 comprised of a quadrilateral shaped mounting base 200 with a plural of rectangular stop tail piece clamps 210 that retain the existing stop tail piece bolts 90 by way of a plural of stop tail piece clamp nuts 213 and bolts 214 that transverse through the entire mounting base 200, and a plural of stop tail piece clamps 210 to provide a means for securing the invention to the stringed musical instrument 21 (shown in FIG. 1a) therefore making the invention more rigid. In addition, a plural of bridge nuts 260 located on opposite sides of the elongated centerline of the stringed musical instrument 21 toward the front of the mounting base 200 to help hold the invention in place. Moreover, a plural of support pillars 208 extending downward from the bottom of the mounting base 200 on opposite sides of the elongated centerline of the stringed musical instrument 21. Also showing a rectangular bridge resection 250 in the front section of the mounting base 200 transversely placed to and below the plural of strings 80 for a plural of bridge assemblies 299. A housing body 300 is secured on top of the mounting base 200, so that a lever body 400 can rotate in axis of the housing body 300 by means of pulling a leverage handle 440 away from the mounting base 200, transferring energy through a plural of leverage arms 441 to a main pivot pin 401 located at the rear of said housing body 300. Said lever body 400 also having a plural of tuner extension features 429 that align with the elongated centerline of the stringed musical instrument 21 and is located in the rear of said lever body 400 used when said lever body 400 is pulled away from the mounting base 200 to adjust the tightest pre-set tuning on the invention. Further showing a plural of control rod assemblies 695 that extend through the housing body 300, and mounting base 200 toward a bottom string roller pin 206 along the elongated centerline of the stringed musical instrument 21, used to manipulate the string 80 tension. Also showing a plural of tuner switch rod assemblies 590 that would be located under a top plate 500 attached to the general top center of the invention to provide a means for switching between preset tunings. In this section of the detailed description, FIGS. 3,4,5,6, and 7 show various component detail and views, explaining their general shape and placement.

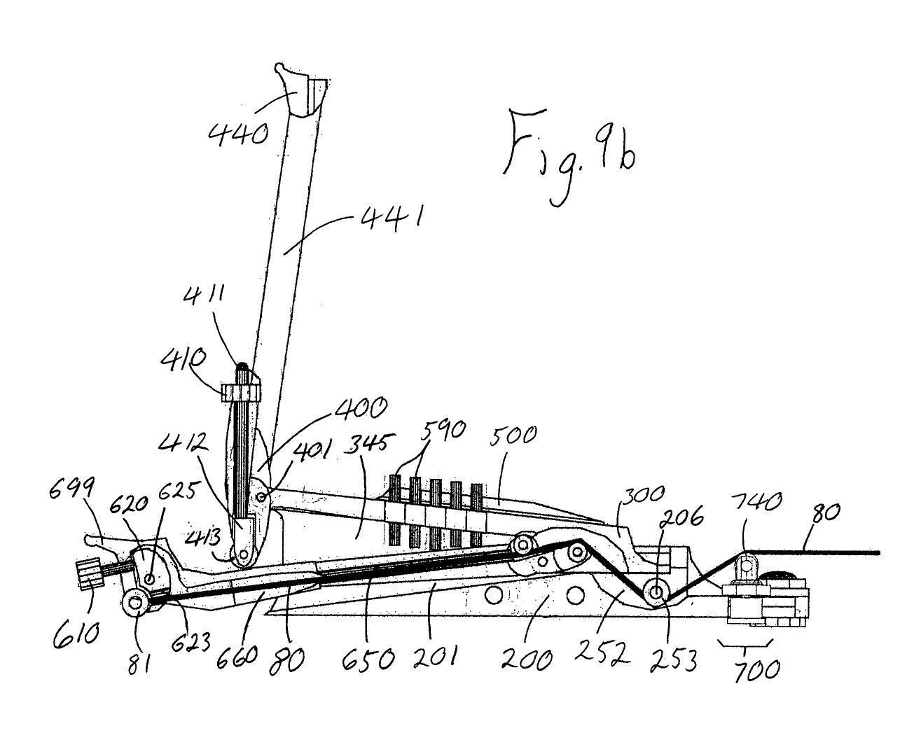

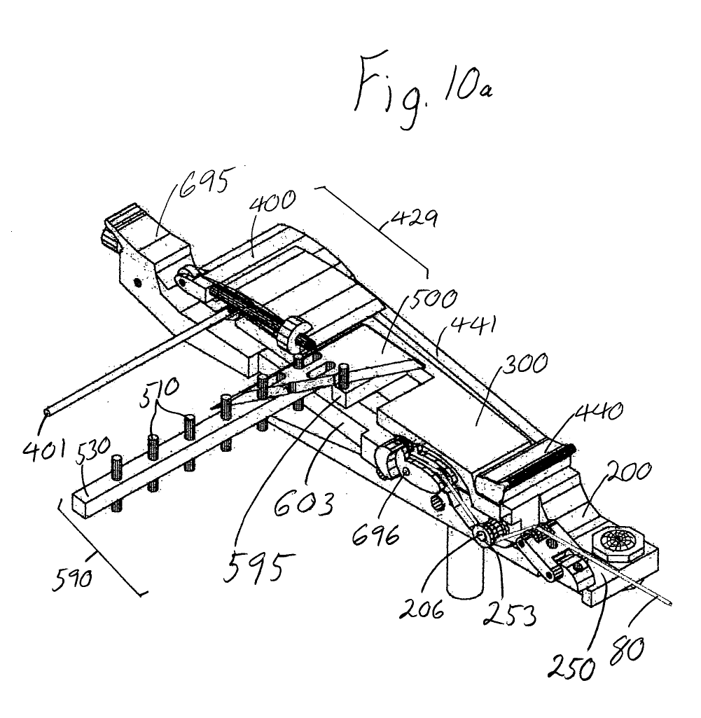

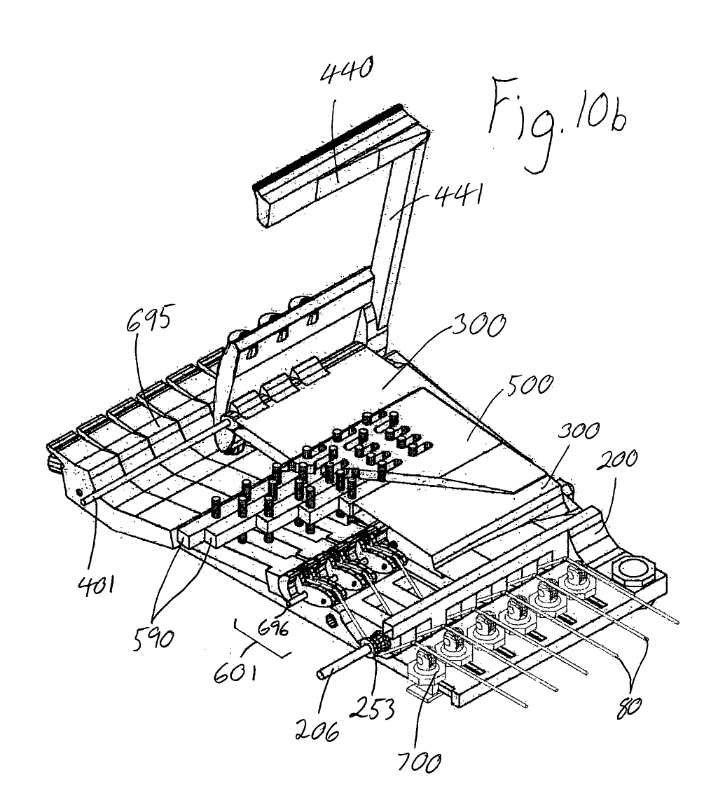

FIG. 3a refers to a perspective view of the mounting base 200 showing the rectangular bridge resection 250 for the bridge assemblies 299 or the alternate bridge assemblies 700 (shown in FIGS. 7b and 7c). Further showing a plural of equally spaced rectangular slots 251 in the mounting base 200, under the bridge resection 250 corresponding to the number of strings 80 on the stringed musical instrument 21 to provide a means for securing the bridge assemblies 299 to said mounting base 200 while allowing, for adjustment of intonation and height, a series of equally spaced, a plural of bottom string roller cavities 252 corresponding to the number of bridge assemblies 299, adjacent and extending in a downward arc from the middle back section of the rectangular bridge resection 250 for the strings 80 to pass through from the control rod body 600 to the bridge assembly 299 or the alternate bridge assembly 700 (shown in FIGS. 9a and 9b), an aperture 205 transversely placed through each bottom string roller cavity 252 for a bottom string roller pin 206 to penetrate (shown in FIG. 3b), a plural of semicircular indentations 203 for the stop tail piece bolts 90 (as shown in FIG. 2) to fit into, a universal flat mounting surface 202 and a plural of apertures 204 positioned transversely through the mounting base 200, on each side of each semicircular indentation 203 to provide a means for the stop tail piece clamps 210 (shown in FIG. 2), to be securely affixed to the mounting base 200. A large angled lower control rod component cavity 201 located in the center back portion of the mounting base 200 to facilitate the internal mechanical components of the present invention. And a plural of support pillars 208 extending downward from the bottom of the mounting base 200, positioned so that a plural of vertical apertures 207, extends through both the outer front sections of the mounting base 200 and each support pillar 208 on opposite sides of the elongated centerline of the stringed musical instrument 21, to provide a solid footprint for mounting the invention to the stringed musical instrument 21. Whereas placing the mounting base 200 over bridge post 31 (shown in FIG. 1b) and screwing the bridge nut 260 on to said bridge post 31 further secures the invention to the stringed musical instrument 21. Further showing a plural of threaded apertures located on opposite corners and through the mid and back outer sections of the mounting base 200 to provide a means for securing the housing body 300 to the mounting base 200 (shown in FIG. 10a).

In accordance with the present invention, FIG. 3b refers to a plain view of the mounting base 200 showing a plural of bottom string rollers 253 counter sank into the bottom string roller cavities 252 so that the bottom string roller pin 206 can retain the bottom string rollers 253 within the mounting base 200 while also allowing the strings 80 to stress while in use. The plural of semicircular indentations 203 with a universal flat mounting surface 202 on each side of the mounting base 200 that accept the stop tail piece bolts 90 so the stop tail piece clamps 210 can firmly grasp the stop tail piece bolts 90 thus holding the invention tightly affixed to the stringed musical instrument 21, also showing the rectangular bridge resection 250 and a plural of equally spaced rectangular slots 254 for the bridge assemblies 299 or the alternate bridge assemblies 700 (shown in FIGS. 7b and 7c), and the large angled lower control rod component cavity 201 in the center back portion of the mounting base 200. Further showing a bridge nut 260, of which there is customarily two located on opposite sides of the bridge area 25, and over the plural of vertical apertures 207 in the mounting base 200, and the plural of threaded apertures 215 in the mounting base 200.

Another section of the present invention shown in FIG. 4a refers to a perspective view of the housing body 300 showing a semicircular pivot structure 310 along the upper back portion of the housing body 300, with a aperture 311 positioned transversely though the semicircular pivot structure 310 along the upper back portion of the housing body 300 to accept the main pivot pin 401 (shown in FIG. 2), a quantum of rectangular shaped extirpations 312 along the semicircular pivot structure 310 to receive a lever body hinge 423 (shown in FIG. 5b), allowing the main pivot pin 401 to create a fulcrum point for the lever body 400 and housing body 300 (shown in FIGS. 9b and 10b), a plural of resections 320 along each side of the housing body 300 for the leverage arms 441, and a resection 321 positioned transversely across the front section of the housing body 300 for the leverage handle 440, facilitating the repeated countersinking of the leverage arms 441 and leverage handle 440 into the housing body 300 while the invention is in use allowing the lever body's 400 size to be diminished within the invention (best shown in FIGS. 9 and 10). A tuner switch rod component cavity 330 of a generally rectangular configuration located in the mid section and countersinking into the housing body 300 from the top downward to provide room for a plural of internal mechanics such as the tuner switch screws 510, and tuner switch rods 530 (shown in FIG. 6b), which are supported on a plural of ledges 340, within the tuner switch rod component cavity 330 in the mid section of the housing body 300, and on opposite sides of the elongated centerline of the stringed musical instrument 21 to facilitate the tuner switch rod's 530 movement transversely to and below the top plate 500 (shown in FIG. 10a). And a plural of housing body stop tailpiece bolt cavities 355 located in the mid-bottom section of the housing body 300. Further showing an upper control rod component cavity 345 in the lower mid to rear section of the housing body 300 to allow room for the control rod assemblies 695 to operate. Further showing a plural of apertures position vertically in the general outer perimeter of the housing body 300 so that the housing body mounting screw can secure the housing body 300 to the mounting base 200 (as shown in FIG. 10a), and a threaded top plate aperture in the housing body 300 to provide a means to secure the top plate 500 to the housing body 300 (as shown in FIG. 10b).

In accordance with the present invention, FIG. 4b refers to a bottom back perspective view of the housing body 300 showing the pivot structure 310, the plural of rectangular shaped extirpations 312 for the lever body hinge 423 (as shown in FIG. 5b), a aperture 311 positioned transversely though the semicircular pivot structure 310 along the upper back portion of the housing body 300 to accept the main pivot pin 401 (shown in FIG. 2), and a tuner switch rod component cavity 330 in the mid section of the housing body 300 to provide room for the tuner switch rods 530 (as shown in FIG. 10a) to move in and out of tuning position. Further showing an upper control rod component cavity 345 located in the lower back portion and extending forward through the lower mid section of the housing body 300. Said upper control rod component cavity 345 is designed to let the control rod's 600 mechanical components (shown in FIG. 7d) function without leaving unnecessary space inside the housing body 300. And a plural of arc shaped extirpations 350 in the lower mid front section of the housing body 300 adjacent to the upper control rod component cavity 345 that receive the control rod's 600 control rod cantilever section 601 (also shown in FIG. 10b) facilitating the fulcrum point for the control rods 600. The plural of arc shaped extirpations 350 correspond to the number of control rods 600, extend vertically from bottom of the housing body 300 across an aperture 326 transpiercing the lower mid front section of the housing body 300, and is sufficiently hollow to permit the fulcrum of the control rod cantilever section 601. Moreover, a plural of housing body stop tailpiece bolt cavities 355 located in the mid-bottom section of the housing body 300, on each side of the elongated centerline of the stringed musical instrument 21.

Another section of the present invention shown in FIG. 5a refers to a perspective view of the lever body 400 having a generally rectangular configuration with rounded edges, showing a plural of leverage arms 441 protruding forward from each side of the rear section of the lever body 400 transferring energy from a leverage handle 440 in the front section of the lever body 400 to the main pivot pin 401 in a aperture 402 (best seen in FIGS. 9 and 10) positioned transversely though the lever body's 400 lower rear section and the housing body's 300 pivot structure 310 (shown in FIGS. 4a and 4b) to provide a fulcrum point for the lever body 400, and said housing body 300, a plural of extirpated cavities equally spaced, and in linear alignment with each other, located in the rear section of the lever body 400. Each cavity is comprised of an aperture 420 in the upper back section of the lever body 400 and is parallel to the elongated centerline of the stringed musical instrument 21. Said aperture 420 is large enough to facilitate the tuner extension adjustment bolt's 411 mechanics (best seen in FIG. 7a) and is also adjoined to a rectangular resection 421 in the furthermost rear section of the lever body 400 allowing the control block 412 to countersink into the lever body 400. Further showing a cylindrical resection 422 located along the horizontal path of said aperture 420 and is sufficiently hollowed to provide clearance for the tuner extension adjustment nut 410 to revolve around the horizontal elongated plane of the tuner extension adjustment bolt 411 while also retaining the tuner extension adjustment nut 410 from movement along the elongated centerline of the stringed musical instrument 21 therefore allowing the tuner extension adjustment nut 410 to facilitate the smooth movement of the tuner extension adjustment bolt 411 and control block 412 to provide a means for the tuner extension feature 429 to operate (shown in FIG. 10a).

In accordance with the present invention, FIG. 5b refers to a perspective bottom view of the lever body 400 revealing a lever body hinge 423 located on the bottom rear section of the lever body 400, generally arc shaped and designed to conjoin the lever body 400, and said housing body 300 at the pivot structure 310 to create the fulcrum point in which the main pivot pin 401 (shown in FIG. 2), is disposed inside both a aperture 402 positioned transversely though the lever body's 400 lower rear section, and the aperture 311 though the semicircular pivot structure 310 (shown in FIGS. 4a and 4b) and allows the lever body 400 to pivot vertically around the housing body 300 creating a cantilever mechanism, further showing the plural of leverage arms 441 protruding forward from each side of the rear section of the lever body 400 to the leverage handle 440 in the front section of the lever body 400, the plural of cylindrical resections 422, and rectangular resections 421 (best shown in FIG. 5a) that facilitate the tuner extension feature 429 (as seen in FIG. 2).

In the present embodiment FIGS. 6a, 6b, and 6c refer to perspective views of the top plate 500, a tuner switch rod assembly 590, and a plural of stop tail piece clamps 210. Said top plate 500 is of a generally rectangular configuration with a plural of tuner switch screw resections 620 that give the tuner switch screws 510 room to move in and out of position, a plural of top plate screws that go through a plural of top plate apertures in to the threaded top plate aperture 307 (shown in FIG. 4a) to securely affix said top plate 500 to the housing body 300. In this embodiment, the top plate 500 is separate from the housing body 300 to facilitate an easier understanding of the invention, although it may be incorporated into the housing body 300 as one piece. The tuner switch rod assembly 590 would be located under the top plate 500 in the tuner switch rod component cavity 330 (shown in FIGS. 4a and 4b). Each tuner switch rod 530 moves independently along a horizontal plane in a perpendicular direction to the elongated centerline of the stringed musical instrument 21, and has a plural of tuner switch screws 510 that correlate to the number of strings 80 on the stringed musical instrument 21. Each tuner switch screw 510 penetrates a vertically threaded aperture through the tuner switch rod 530 to provide a means for adjusting the preset tuning of each tuner switch screw 510. The tuner switch rod component cavity 330 is designed to hold the internal mechanical components of the tuner switch rod assembly 590 without leaving unnecessary space, thus facilitating the smooth movement between (in use, and not in use) for each tuner switch rod 530. Typically there are two stop tail piece bolts 90 (as seen in FIG. 2) therefore two stop tail piece clamps 210 would be used to secure the invention to the stringed musical instrument 21. Each stop tail piece clamp 210 has a plural of horizontal apertures 212 that penetrate the stop tail piece clamp 210 on each side of a cylindrical resection 211 located in the middle inward side of each stop tail piece clamp 210 designed to secure the invention to the stop tailpiece bolt 90.

FIG. 7a shows components of the tuner extension feature 429 and is comprised of a rectangular shaped control block 412 that has a roller bearing 413 inset on one end and retained by the control block pin 414 within aperture 415 through the control block 412 and a tuner extension adjustment bolt 411 extending forward from the opposite end of the control block 412. The tuner extension adjustment bolt 411 pierces the threaded aperture in the tuner extension adjustment nut 410. This assembly is to be incased within the lever body 400 (as shown in FIG. 10a).

Another section of the present invention shown in FIG. 7b is the bridge assembly 299, comprised of a bridge mount 220, with a mounting screw 221 penetrating both the vertical aperture 223 in the bridge mount 220, and a threaded aperture 224 in a wedge nut 222. Said wedge nut 222 is pulled into the rectangular slot 251 (shown in FIGS. 3a and 3b) by rotating said mounting screw 221 to provide a means for securing the bridge mount 220 firmly to the mounting base 200. A bridge arm 230 which is of a generally rectangular H-shaped configuration, is pined to the bridge mount 220 via a lower bridge arm pin 241 that is inserted into both a lower bridge arm aperture 243 and a horizontal bridge mount aperture 245 at the bottom of the bridge arm 230 to form a fulcrum point for the bridge arm 230 to have a cylindrical rotation around the upper section of the bridge mount 220 by turning a height adjustment screw 231 that rest on a height adjustment mount 234 rotating within a threaded vertical bridge arm aperture 232 allowing for string 80 height adjustment. A bridge roller 240 is counter sank into the top of the bridge arm 230 and held in place by a upper bridge arm pin 242 which transpierces both a upper bridge arm aperture 244 and a bridge roller aperture 233 to provide the last point of contact for the string, while allowing complete control of intonation and height as the string 80 stresses from the use of the internal mechanics of the invention.

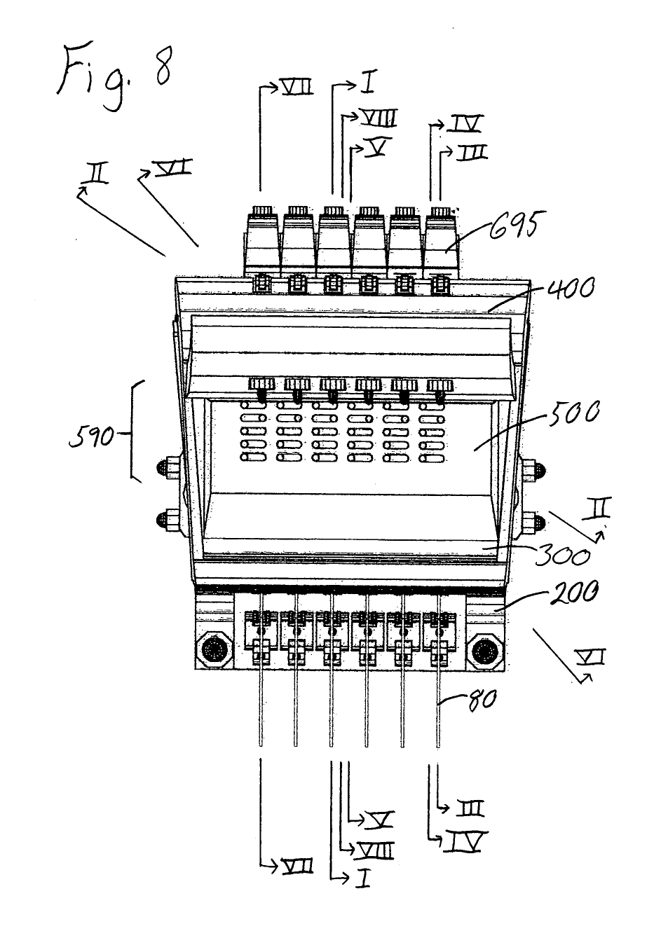

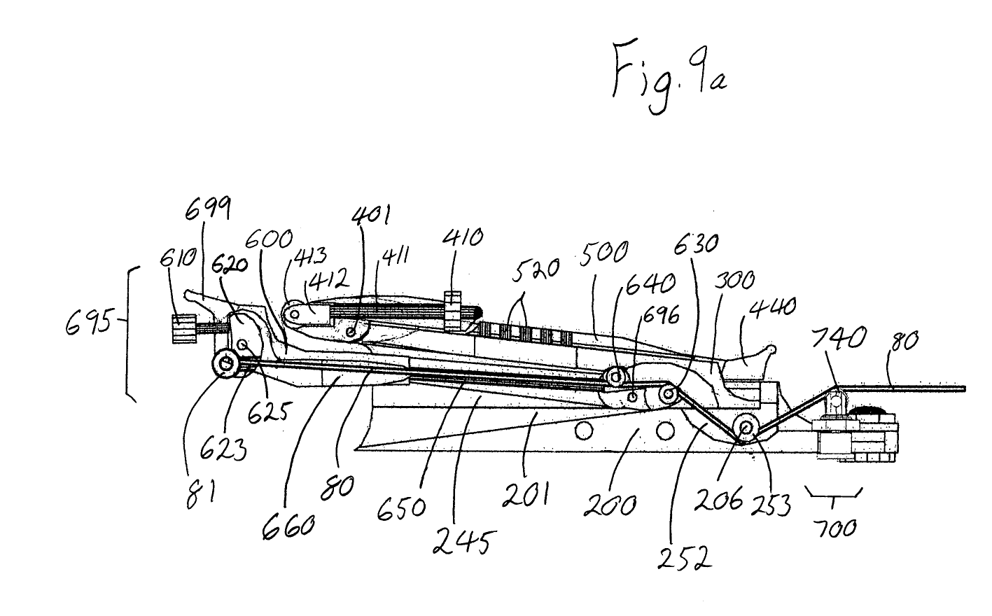

FIG. 7c refers to an exploded view of an alternate bridge assembly 700 (shown in FIGS. 8, 9a, 9b, and 10b) comprising an upside-down T-shaped retaining member 710, that has a threaded column 711 extending vertically from the general midsection of said retaining member 710. An alternate bridge roller 740 counter sank into the top of a roller support column 720 retained by a alternate bridge roller pin 725 within both a horizontal aperture 726 across a roller support column 720 and a alternate bridge roller aperture 727 to provide an adjustable last point of contact, while allowing the string 80 to stress from the internal mechanics of the invention. The externally threaded roller support column 720, with a threaded aperture 721 in the bottom, extending vertically through the center of the roller support column 720 for the threaded column 711 to screw into, allowing a support column lock nut 730 to pull up on the roller support column 720 That rest on the mounting base 200 (shown in FIG. 10b) which therefore pulls the threaded column 711 on the retaining member 710, securely clamping the alternate bridge assembly 700 to the mounting base 200 while allowing complete control of intonation and height.
In FIG. 7d an exploded view of the control rod assembly 695 is shown, comprised of a control rod body 600 having an elongated shape to facilitate the manipulation of string 80 tension by using leverage, a knurled head bolt 610 to adjust a fine tuning control lever 620 retained by a fine tuning control lever pin 625 in the general back section of the control rod body 600, under a control rod handle 699. Also showing a control rod cantilever section 601 in the general front of the control rod body 600, with an aperture 602 placed at the general mid-point of the control rod cantilever section 601, and transversely to the elongated centerline of the control rod body 600, to provide a fulcrum point for the control rod cantilever section 601 of the control rod body 600. The control rod cantilever section 601 is comprised of a forward string roller 630, retained by a forward string, roller pin 635 and a aft string roller 640, retained by a aft string roller pin 645, on each side of, and parallel to the aperture 602 in the control rod cantilever section 601. The forward string roller 630 is designed to bend the string 80 up while the aft string roller 640 is designed to bend the string 80 down, increasing the amount of force generated by the length of the control rod body 600. Further showing a plural of symmetrical resections 603 located on each side of the midsection of the control rod body 600 to allow the tuner switch screws 510 (shown in FIG. 6b) room to function.

FIG. 8 shows a plain view of the fully assembled invention for the cut away view layouts shown in FIGS. 9 and 10 illustrating the cut away path of each component and meant to show the relation of each component within the invention. Roman Numeral I shows the cross-section path in the mounting, base 200, housing body 300, lever body 400, and the control rod assembly 695 to illustrate how the string 80 is manipulated in FIG. 9; Roman Numeral II shows the cutaway path in the top plate 500 illustrating the relation between tuner switch rod assembly 590, and control rod assemblies 695; Roman Numeral III shows a cutaway path in the mounting base 200, housing body 300, and lever body 400 to allow for the viewing of the internal components within the invention; Roman Numeral IV shows a cutout in one tuner switch rod 530 further described in FIG. 10a. In FIG. 10b, Roman Numeral V represents the cutaway in the lever body 400; Roman Numeral VI is the cutaway in top plate 500; Roman Numeral VII represents the cutaway in mounting base 200; Roman. Numeral VIII is the cutaway in housing body 300.

FIGS. 9a and 9b shows a cross-section path through the invention along the (Roman Numeral I) showing the relation of the control rod assembly 695 to the guitar string 80. Said control rod assembly 695 is comprised of a control rod body 600, which houses a knurled head bolt 610 and a fine tuning control lever 620, that is held in place and pivots on the fine tuning control lever pin 625, which is covered by a control rod handle 699. The guitar string 80 passes through an aperture 623 parallel to the elongated centerline of the stringed musical instrument 21, in the bottom portion of the fine tuning control lever 620 being held in place by a guitar string stop 81 located at one end of each guitar string 80. The guitar string then passes through an aft string void 660 and a forward string void 650 until it comes in contact with the bottom portion of the aft string roller 640. The string then passes over the forward string roller 630, under the bottom string roller 253 located in the general med section of the mounting base 200, and over the alternate bridge roller 740, which is the last contact point for the guitar string 80 and is located within the alternate bridge assembly 700. The control rod assembly 695 held in place by the control rod pin 696 which is located in the general mid section of housing body 300 and allows for the movement of the control rod cantilever section 601 (shown in FIG. 7d), thus forming a fulcrum point for the control rod assembly 695 at said control rod pin 696. So that when the leverage handle 440 is pulled upward and away from the housing body 300 (as shown in FIG. 9b) it transfers energy through the leverage arms 441 and lever body 400 to the main pivot pin 401, as the lever body 400 pivots on the main pivot pin 401 it then transfers the energy through the tuner extension adjustment nut 410 which holds the tuner extension adjustment bolt 411 and the control block 412 within the lever body 400. The control block 412 retains a roller bearing 413, which allows for smoother movement across the control rod body 600 as the lever body 400 pivots. The upper control rod component cavity 345 and lower control rod component cavity 201 allow the control rod assembly 695 the room to move freely within the confines of the invention, while pivoting on the control rod pin 696. This applies force to the guitar strings 80 while also allowing them to stress, via the forward string rollers 630 and the aft string rollers 640. The bottom string roller pin 206 retains the bottom string rollers 253 inside each bottom string rollers cavity 252 within the mounting base 200, giving the guitar string 80 a stationary angle before reaching the alternate bridge roller 740 the last contact point for the guitar string 80 before it is stretched across the guitar neck 23. FIG. 9a shows the tuner switch screw resections 520 in the top plate 500 with the tuner switch rod assembly 590 removed to reveal a better view of the 695 but in FIG. 9b the tuner switch rod assembly 590 is shown to show the relation of tuner switch rod assembly 590 and control rod assembly 695 when the leverage handle 440 is in the raised position.

FIGS. 10a and 10b show perspective views of the invention, FIG. 10a shows a cut away path along the (Roman Numeral II, shown in FIG. 8) in the top plate 500 revealing a cutaway tuner Switch rod assembly 595 at (Roman Numeral IV). This shows how one tuner switch rod assembly 590 can rest beside the control rod assemblies 695 and one selected tuner switch rod assembly 590 holds the control rod assemblies 695 in position. The tuner switch screws 510 screw into the tuner switch rods 530, therefore turning the tuner switch screws 510 in one direction or the other will lower or raise the control rod assemblies 695 that are held in place by that selected tuner switch rod assembly 590. The other tuner switch screws 510 that are in the non-selected tuner switch rod assemblies 590 rest beside the symmetrical resections 603 located on each side of the midsection of the control rod body 600. A separate cut away path along the (Roman Numeral III) in FIG. 10a shows the mounting base 200, housing body 300 and lever body 400, all cutaway along the same line so as to show the relationship between the tuner switch rod assemblies 590 and the control rod assemblies 695. Further showing the housing body mounting screws 306 designed to securely affix the housing body 300 to the mounting base 200. When the leverage handle 440 is raised (as shown in FIG. 10b) the energy is transferred through the leverage arms 441 to the lever body 400, pivoting on the main pivot pin 401 pushing the control rod assemblies 695 downward pivoting on the control rod cantilever section 601 adding stress to the guitar strings 80. This stress is transferred along the guitar strings 80 across the bottom string rollers 253 which are held in place by the bottom string roller pin 206 to the alternate bridge assemblies 700 that are located in the rectangular bridge resection 250. The rollers that are incorporated into the invention allow the stress within the guitar strings 80 to be manipulated freely across the length of the guitar string 80 without having to worry about slippage. FIG. 10b also shows a cut away path along the (Roman Numeral V, shown in FIG. 8) in the lever body 400 to better show the relation between the control rod assemblies 695 and lever body 400. FIG. 10b also shows a cut away path along the (Roman Numeral VI) in the top plate 500 which permits viewing of the tuner switch rods 530, a cut away path along the (Roman Numeral VII) in the mounting base 200, a cut away path along the (Roman Numeral VII) in the housing body 300 to help show the control rod pin 696 which is located in the general mid section of housing body 300 and the relation of lever body 400 and control rod assemblies 695. Further showing a plural of top plate screws 506 designed to securely affix said top plate 500 to the housing body 300.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for changing the key of a stringed musical instrument, comprising:
a mounting base having a means for securely affixing the mounting base to a front mid-section of a stringed musical instrument;
a housing body that is secured to the top of the mounting base;
a plurality of control rod assemblies that extend through the housing body and the mounting base for increasing or decreasing tension of strings of the stringed musical instrument;
a plurality of tuner switch rod assemblies, disposed within the housing body, that provide a means for switching between preset tunings;
means for the tuner switch rod assemblies in the housing body;
a lever body attached to the housing body, the lever body having a lever arms, one lever arm protruding forward from each side of the rear section of the lever body and each lever arm terminating in a lever handle;
a plurality of tuner extensions, located in the rear of the lever body, the tuner extensions allowing the tightest pre-set tuning to be adjusted; and
a plurality of bridge assemblies providing an adjustable last contact point for the strings, the number of bridge assemblies corresponding to the number of strings on the stringed musical instrument.

2. A machine for changing the key of a stringed musical instrument according to claim 1, further comprising:
at least two stop tailpiece clamps for securing the mounting base to the stringed musical instrument;
at least two semicircular indentations, one on each side of the mounting base, each of the semicircular indentations receiving one of the stop tailpiece bolts, and allowing the stop tailpiece clamps to secure the mounting base to the stringed musical instrument; and
means for securely affixing the mounting base to the stop tail piece bolts.

3. A machine for changing the key of a stringed musical instrument according to claim 2, further comprising:
a plurality of bridge nuts that screw onto bridge posts on the stringed musical instrument, the bridge posts extending through the outer front section of the mounting base and on opposite sides of the elongated centerline of the stringed musical instrument.

4. A machine for changing the key of a stringed musical instrument according to claim 2, further comprising:
a substantially flat, rectangular bridge cut-out section, located at the front of the mounting base, to facilitate the mounting of the bridge assemblies; and
means for locking of the bridge assemblies on a plane parallel to the strings of the stringed instrument.

5. A machine for changing the key of a stringed musical instrument according to claim 2, further comprising:
a plurality of bottom string rollers, located within bottom string roller cavities, that assist in tensioning the strings, wherein each of the strings passes through a bottom string roller cavity adjacent to and extending in a downward arc from the middle back section of the rectangular bridge cut-out section, from a forward string roller to the bottom string roller.

6. A machine for changing the key of a stringed musical instrument according to claim 2, further comprising:
a lower control rod cut-out section, located in the center back portion of the mounting base, to accommodate placement of control rod components.

7. A machine for changing the key of a stringed musical instrument according to claim 1, wherein the housing body has an upper control rod cut-out section to accommodate placement of control rod components; and
a tuner switch rod cut-out section, located in the mid-section and countersunk into the housing body from the top downward, to provide room for the tuner switch rods.

8. A machine for changing the key of a stringed musical instrument as described in claim 7, further comprising:
means for attaching the lever body to the housing body, wherein the attaching means comprises a main pivot pin that creates a fulcrum point for the control rod assemblies.

9. (canceled)

10. A machine for changing the key of a stringed musical instrument according to claim 7, further comprising:
a plurality of arc-shaped grooves extending vertically from the bottom of the housing body to permit the control rod cantilever section to pivot therein, thereby facilitating the pivoting of the control rods.

11. A machine for changing the key of a stringed musical instrument according to claim 1, further comprising:
a fine tuning control lever retained under a control rod handle by a fine tuning control lever pin in the general back section of each control rod body;
a knurled head bolt to adjust the fine-tuning control lever in the back section of the control rod body; and
wherein each of the control rod assemblies has a control rod body of a generally rectangular, elongated shape to facilitate the manipulation of string tension by using leverage.

12. A machine for changing the key of a stringed musical instrument according to claim 11, further comprising:
an aperture in the mid-section of the control rod cantilever section on the control rod body to provide a pivot point for the control rod assembly; and
a forward string roller and an aft string roller that are positioned on opposite sides of the aperture in the control rod cantilever section.

13. A machine for changing the key of a stringed musical instrument according to claim 11, further comprising a plurality of symmetrical cut-outs located on each side of the mid-section of the control rod body to allow the tuner switch rod assembly room to switch from an in-use setting to a not-in-use setting.

14. A machine for changing the key of a stringed musical instrument according to claim 1, further comprising:
a tuner switch rod assembly having a plurality of tuner switch rods that move independently along a horizontal plane in a direction perpendicular to the elongated centerline of the stringed musical instrument and that rest in the tuner switch rod component cavity, to facilitate the smooth movement between in use and not-in-use settings for each tuner switch rod;
a plurality of tuner switch screws that correlate to the number of strings on the stringed musical instrument and that penetrate a vertically-threaded aperture through the tuner switch rod to provide a means for adjusting the preset tuning of each control rod assembly.

15. A machine for changing the key of a stringed musical instrument according to claim 1, further comprising:
a top plate, of a generally rectangular configuration, having a plurality of tuner switch screw slots that give the tuner switch screws room to move in and out of position.

16. A machine for changing the key of a stringed musical instrument according to claim 1, wherein
the tuner extension includes a tuner extension adjustment nut with a threaded aperture and a tuner extension adjustment bolt that pierces the threaded aperture in the tuner extension adjustment nut to allow for adjustment of the tuner extension; and
a roller bearing inset on one end of a control block affixed to one end of the tuner extension adjustment bolt to facilitate a smooth movement while manipulating the lever body.

17. A machine for changing the key of a stringed musical instrument according to claim 1, wherein the lever body has a generally rectangular configuration and rounded edges.

18. A machine for changing the key of a stringed musical instrument according to claim 17, further comprising:
an aperture in the upper back section of the lever body that is parallel to the elongated centerline of the stringed musical instrument and is large enough to accommodate the tuner extension adjustment bolt;
a rectangular section in the furthermost rear section of the lever body to allow the control block to countersink into the lever body; and
a cylindrical section, located along the horizontal path of the aperture in the upper back section of the lever body, that is sufficiently hollowed to provide clearance for the tuner extension adjustment nut to revolve around the horizontal elongated plane of the tuner extension adjustment bolt while also restraining the tuner extension adjustment nut from movement along the elongated centerline of the stringed musical instrument.

19. A machine for changing the key of a stringed musical instrument according to claim 8, wherein the lever body pivots vertically around the housing body, thereby creating a cantilever action that manipulates the control rod assembly.

20. A machine for changing the key of a stringed musical instrument according to claim 1, further comprising:
a bridge assembly having a bridge roller that is countersunk into the top of a bridge arm, the bridge assembly having a generally rectangular, H-shaped configuration and providing the last point of contact for the string, while allowing complete control of intonation and height as the string tensions;
a height adjustment screw that can be rotated within a threaded vertical bridge arm aperture, thereby allowing for string height adjustment;
a bridge mount that is of a generally arc-shaped configuration and designed to affix the bridge arm to the invention while allowing for string height adjustment;
a wedge nut and an associated mounting screw penetrating both a vertical aperture in the bridge mount and a threaded aperture in the wedge nut, thereby allowing for the adjustment of string intonation while securely affixing the bridge assembly to the mounting base.

21. A machine for changing the key of a stringed musical instrument, comprising:
a mounting base having a means for securely affixing the mounting base to a front mid-section of a stringed musical instrument;
a housing body that is secured to the top of the mounting base;
a plurality of control rod assemblies that extend through the housing body and the mounting base for increasing or decreasing tension of strings of the stringed musical instrument;
a plurality of tuner switch rod assemblies, disposed within the housing body, that provide a means for switching between preset tunings;
means for the tuner switch rod assemblies in the housing body;
a lever body attached to the housing body, the lever body having a lever arms, one lever arm protruding forward from each side of the rear section of the lever body and each lever arm terminating in a lever handle;
a plurality of tuner extensions, located in the rear of thethe lever body, the tuner extensions allowing the tightest pre-set tuning to be adjusted; and
an alternate bridge assembly with an alternate bridge roller that allows the string to stress from the internal mechanics of the invention;
an externally threaded roller support column that supports said alternate bridge roller while allowing the string to stress from the internal mechanics of the invention;
an upside-down T-shaped retaining member, that has a threaded column extending vertically from the general mid-top section of said retaining member; and
a support column lock nut that secures said roller support column to said mounting base by pulling up on said roller support column that is screwed onto said threaded column extending vertically from the general mid-top section of said retaining member.
